(19) United States
(12) Patent Application Publication
(10) Pub. No.: US 2025/0022178 A1
(43) Pub. Date: Jan. 16, 2025

(54) METHOD FOR ENCODING/DECODING VIDEO FOR MACHINE AND RECORDING MEDIUM STORING THE METHOD FOR ENCODING VIDEO

(71) Applicants: Electronics and Telecommunications Research Institute, Daejeon (KR); UNIVERSITY-INDUSTRY COOPERATION GROUP OF KYUNG HEE UNIVERSITY, Yongin-si (KR)

(72) Inventors: Joo Young LEE, Daejeon (KR); Se Yoon Jeong, Daejeon (KR); Youn Hee Kim, Daejeon (KR); Jin Soo Choi, Daejeon (KR); Jung Won Kang, Daejeon (KR); Hye Won Jeong, Yongin-si (KR); Hui Yong Kim, Yongin-si (KR); Jang Hyun Yu, Yongin-si (KR); Seung Hwan Jang, Yongin-si (KR); Hyun Dong Cho, Yongin-si (KR)

(73) Assignees: Electronics and Telecommunications Research Institute, Daejeon (KR); UNIVERSITY-INDUSTRY COOPERATION GROUP OF KYUNG HEE UNIVERSITY, Yongin-si (KR)

(21) Appl. No.: 18/770,167

(22) Filed: Jul. 11, 2024

(30) Foreign Application Priority Data
Jul. 12, 2023 (KR) 10-2023-0090390
Jul. 2, 2024 (KR) 10-2024-0087140

(51) Int. Cl. G06T 9/00; G06T 3/40; G06V 10/44

(52) U.S. Cl. CPC G06T 9/00; G06T 3/40; G06V 10/44

(57) ABSTRACT

The present disclosure relates to an image encoding/decoding method for a machine and a device therefor. An image encoding method according to the present disclosure includes extracting an encoding method feature from an encoding input signal; determining an encoding method that is optimal for the encoding input signal based on the encoding method feature; transforming the encoding input signal based on the encoding method; and encoding an encoding target signal generated by transforming encoding method information and the encoding input signal.

### TECHNICAL FIELD

The present disclosure relates to a method for encoding/decoding an image for a machine and a device therefor.

### BACKGROUND ART

A traditional image compression technology has been developed to ensure that when a compressed image is reconstructed, a reconstructed image is as similar as possible to the original based on human vision. In other words, an image compression technology has been developed towards minimizing a bit rate and maximizing the image quality of a reconstructed image at the same time.

As an example, an encoder receives an image as input to generate a bitstream through a transform and entropy encoding process for an input image, and a decoder receives a bitstream as input to reconstruct it to an image similar to the original.

To measure similarity between an original image and a reconstructed image, an objective image quality evaluation scale or a subjective image quality evaluation scale may be used. Here, Mean Squared Error (MSE), etc. which measures a difference in pixel values between an original image and a reconstructed image is mainly used as an objective image quality evaluation scale. Meanwhile, a subjective image quality evaluation scale means that a person evaluates a difference between an original image and a reconstructed image.

Meanwhile, as machine vision working performance has been improved, a growing number of machines, instead of persons, have watched and consumed an image. As an example, in fields such as a smart city, an autonomous car, an airport surveillance camera, etc., an increasing number of images are used based on machines, not persons.

Accordingly, recently, other than traditional image compression focusing on persons, there is a growing interest in an image compression technology centered on machine vision.

### DISCLOSURE

### Technical Problem

The present disclosure provides a method for encoding/decoding an encoding input signal by selecting an encoding method that is optimal for an encoding input signal.

The present disclosure provides a method for transforming an encoding input signal according to an optimal encoding method and encoding/decoding information regarding the transform.

The technical objects to be achieved by the present disclosure are not limited to the above-described technical objects, and other technical objects which are not described herein will be clearly understood by those skilled in the pertinent art from the following description.

### Technical Solution

An image encoding method according to the present disclosure includes extracting an encoding method feature from an encoding input signal; determining an encoding method that is optimal for the encoding input signal based on the encoding method feature; transforming the encoding input signal based on the encoding method; and encoding an encoding target signal generated by transforming encoding method information and the encoding input signal.

In an image encoding method according to the present disclosure, the encoding method information may include an encoding method index indicating the encoding method among a plurality of encoding method candidates.

In an image encoding method according to the present disclosure, the encoding method feature may be output as a response to inputting an input signal generated by combining the encoding input signal and a compression ratio determination parameter into a first machine learning model.

In an image encoding method according to the present disclosure, the input signal may be generated by transforming the compression ratio determination parameter according to the spatial resolution of the encoding input signal and combining a transformed compression ratio determination parameter and the encoding input signal in a channel direction.

In an image encoding method according to the present disclosure, the input signal may be generated by transforming the encoding input signal according to the dimension of the compression ratio determination parameter and combining a transformed encoding input signal and the compression ratio determination parameter in a channel direction.

In an image encoding method according to the present disclosure, the compression ratio determination parameter is a multi-channel signal having as many channels as the number of compression ratio determination parameter candidates, and in the multi-channel signal, only a channel corresponding to a compression ratio determination parameter candidate to be used among the compression ratio determination parameter candidates may be set to be activated.

In an image encoding method according to the present disclosure, the first machine learning model may be learned by applying a loss function to a latent space feature alignment value derived from the encoding method feature.

In an image encoding method according to the present disclosure, the latent space feature alignment value may be obtained by arranging the encoding method feature on a latent space alignment axis according to the compression determination parameter.

In an image encoding method according to the present disclosure, the loss function may use a distance between the latent space feature alignment value and a median value of a correct encoding method as a variable.

In an image encoding method according to the present disclosure, the loss function uses a distance between the latent space feature alignment value and a threshold range of a correct encoding method as a variable, and the loss function may be applied only when the latent space feature alignment value does not belong to the threshold range of the correct encoding method.

In an image encoding method according to the present disclosure, the threshold range may not include a margin set around a boundary between encoding methods.

In an image encoding method according to the present disclosure, the predicted encoding method may be output as a response to inputting an output signal of the first machine learning model to a second machine learning model.

In an image encoding method according to the present disclosure, the second machine learning model may be learned based on a loss function based on a risk between a predicted encoding method and a correct encoding method.

In an image encoding method according to the present disclosure, the risk may increase as a difference between an index of the predicted encoding method and an index of the correct encoding method increases.

In an image encoding method according to the present disclosure, the loss function may be a function that uses the risk as a weight for a loss value.

In an image encoding method according to the present disclosure, the encoding target signal may be generated by adjusting at least one of resolution or the number of channels of the encoding input signal.

In an image encoding method according to the present disclosure, the encoding method information may further include resolution adjustment information for the encoding target signal.

In an image encoding method according to the present disclosure, the encoding method information may further include difference value information between a compression ratio determination parameter of the encoding input signal and a compression ratio determination parameter of the encoding target signal.

An image decoding method according to the present disclosure may include receiving a bitstream including metadata and encoded image data; decoding the encoded image data to generate a reconstructed encoding target signal; and transforming the reconstructed encoding target signal to generate a reconstructed encoding target signal. In this case, the metadata includes encoding method information indicating an encoding method of the encoded image data, and decoding of the encoded image data may be performed based on a decoding method corresponding to an encoding method indicated by the encoding method information.

According to the present disclosure, a computer readable recording medium recording the image encoding method may be provided.

The technical objects to be achieved by the present disclosure are not limited to the above-described technical objects, and other technical objects which are not described herein will be clearly understood by those skilled in the pertinent art from the following description.

### Technical Effect

According to the present disclosure, an optimal encoding method for an encoding input signal may be selected and an encoding input signal may be encoded/decoded, increasing a compression ratio.

According to the present disclosure, an encoding input signal may be transformed according to an optimal encoding method and information on the transform may be encoded/decoded, increasing a compression ratio.

Effects achievable by the present disclosure are not limited to the above-described effects, and other effects which are not described herein may be clearly understood by those skilled in the pertinent art from the following description.

### BRIEF DESCRIPTION OF DRAWINGS

FIGS. 1(a) and 1(b) schematize a difference between an image compression technology for human vision and an image compression technology for machine vision.

FIG. 2 shows an example in which a multi-layer feature map is extracted by a machine work performance model.

FIG. 3 shows an example in which an encoding input signal is adaptively selected.

FIG. 4 illustrates a performance difference according to an encoding method.

FIGS. 5 and 6 are a flowchart of an image encoding method and an image decoding method according to an embodiment of the present disclosure, respectively.

FIG. 7 shows a block diagram of an image encoder for performing an image encoding method shown in FIG. 5.

FIG. 8 shows a block diagram of an image decoder for performing an image decoding method shown in FIG. 6.

FIG. 9 illustrates an encoding method feature extraction unit built based on an artificial neural network.

FIGS. 10(a) and 10(b) show an example of comparing a case in which the selection order of encoding methods is maintained according to a compression ratio determination parameter and a case in which it is not.

FIG. 11 shows an example in which an encoding method feature is arranged according to an encoding method on a latent space feature alignment axis on a latent space.

FIGS. 12(a) and 12(b) show an example in which an error occurs in prediction of an encoding method.

FIGS. 13 and 14 show an example in which an encoding method is determined without considering the selection order of encoding methods.

FIGS. 15 and 16 show an example in which an encoding method is determined by considering the selection order of encoding methods.

FIG. 17 shows an example in which an encoding input signal and a compression ratio determination parameter are merged.

FIGS. 18 and 19 show an example in which a compression ratio determination parameter is transformed according to the spatial resolution of an encoding input signal.

FIGS. 20 and 21 show an example in which a loss function is applied to a latent space feature alignment value.

FIG. 22 is an exemplary diagram for describing a feature value center alignment loss function.

FIG. 23 is an exemplary diagram for describing a feature value alignment loss function using a threshold.

FIG. 24 is an exemplary diagram for describing a feature value alignment loss function using a margin threshold.

FIG. 25 shows an example in which a threshold range is subdivided by encoding method.

FIG. 26 shows an example in which an encoding method determination unit is implemented by using a fully connected layer.

FIG. 27 is an exemplary diagram for describing a risk-taking classification loss function.

FIGS. 28 and 29 show an example of a risk function.

FIG. 30 shows an example in which an encoding target signal has a compression ratio determination parameter different from an encoding input signal.

### MODE FOR INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from another element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

An image compression technology for machine vision minimizes a compression bit rate, but unlike an image compression technology for human vision, it is intended to maximize the performance of a machine vision work through a reconstructed image, not the image quality of a reconstructed image.

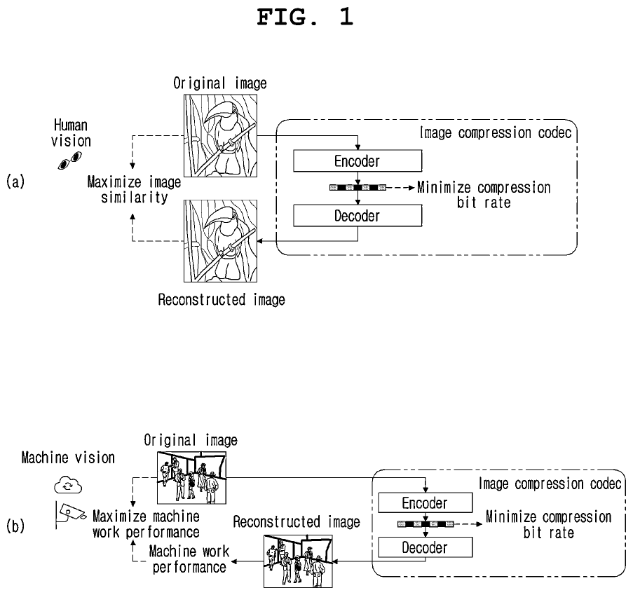

FIGS. 1(a) and 1(b) schematize a difference between an image compression technology for human vision and an image compression technology for machine vision.

FIG. 1(a) shows an image compression technology for human vision, and FIG. 1(b) shows an image compression technology for machine vision.

Image compression for machine vision may extract a feature map from an image and compress an extracted feature map, instead of compressing an image as it is. Here, a feature map may be extracted by a machine work performance model.

An image compression technology for machine vision may be optimized towards minimizing a compression bit rate of a feature map and maximizing machine work performance when performing a machine work based on a reconstructed feature map.

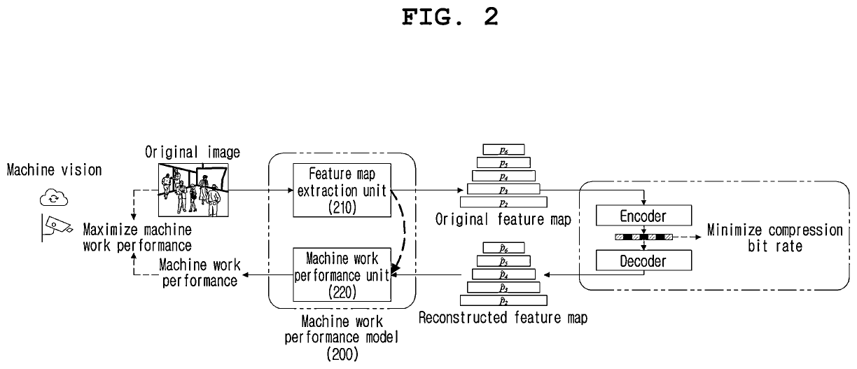

FIG. 2 shows an example in which a multi-layer feature map is extracted by a machine work performance model.

A machine work performance model 200 may be divided into a feature map extraction unit 210 and a machine work performance unit 220. In this case, a feature map extraction unit 210 and a machine work performance unit 220 may be implemented by a different device, respectively. As an example, a feature map extraction unit 210 may be included in a terminal for encoding, and a machine work performance unit 220 may be included in a terminal for decoding.

A feature map extraction unit 210 and a machine work performance unit 220 may be implemented on a different device, reducing computing burden of each device. Meanwhile, since it is difficult for a person to watch and identify an object, a feature map may be helpful for personal information protection.

An encoding input signal for machine work performance may be an image itself or may be a feature map extracted from input. Meanwhile, a feature map to be encoded may be a single-layer feature map or a multi-layer feature map. Alternatively, an image or a feature map may be partitioned into a plurality of blocks and an encoding input signal may be set in a unit of a block.

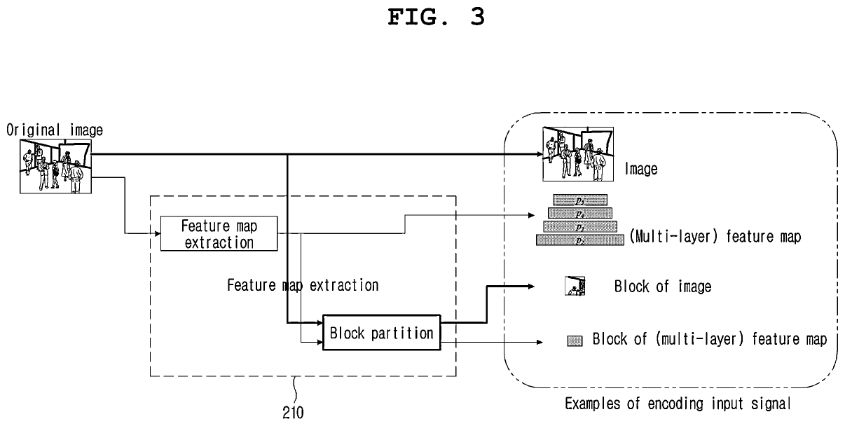

FIG. 3 shows an example in which an encoding input signal is adaptively selected.

In the present disclosure, a method for determining an optimal encoding method according to a compression bit rate among a plurality of compression encoding methods is proposed.

When an image or a feature map is compressed, a compression bit rate range for a predetermined item may be different according to an encoding method. As an example, a first encoding method may show high performance in a low bit rate range, but low performance in a high compression bit rate range, and a second encoding method may show high performance in a high compression bit rate range, but low performance in a low bit rate range.

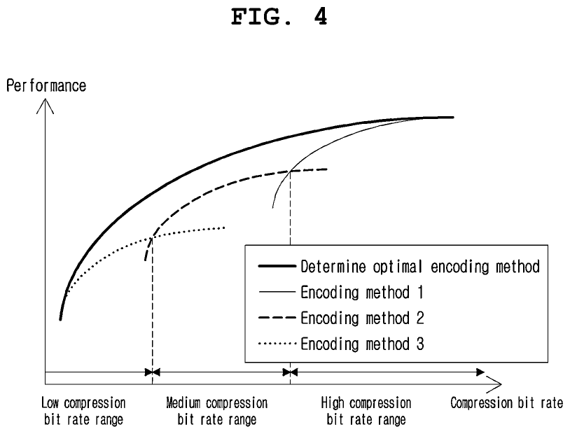

FIG. 4 illustrates a performance difference according to an encoding method.

FIG. 4 illustrated that three encoding methods are different in performance according to a compression bit rate.

When the performance of three encoding methods is the same as in an example shown in FIG. 4, it is effective to select Encoding Method 3 in a low compression bit rate range. In addition, it is effective to select Encoding Method 2 in a medium compression bit rate range and to select Encoding Method 1 in a high compression bit rate range.

In other words, when a compression encoding method with the best performance is different per compression bit rate, encoding efficiency may be increased by selecting an optimal encoding method according to a compression bit rate. To this end, the present disclosure proposes a method for selecting an optimal encoding method for a given compression bit rate range.

A plurality of encoding method candidates may include a plurality of types of codecs. A plurality of types of codecs may include at least one of a codec for human vision (e.g., AV1, HEVC, or VVC) or an artificial intelligence-based codec.

Alternatively, a plurality of encoding method candidates may be different in at least one of whether to perform temporal resampling, whether to adjust spatial resolution, whether to change a compression ratio determination parameter or whether to process a region of interest.

Meanwhile, a compression bit rate may be determined by a compression ratio determination parameter. Accordingly, an optimal compression encoding method may be determined by a sample and a compression ratio parameter of a corresponding sample. Accordingly, an optimal compression encoding method between samples may be different according to a compression ratio determination parameter of each sample of an encoding input signal.

A determination of an optimal compression encoding method may be performed by a compression bit rate adaptive encoding method determination unit. A compression bit rate adaptive encoding method determination unit may determine an optimal encoding method for a sample in advance according to a compression ratio determination parameter of a sample, which may be learned by a predicted neural network. In other words, a compression bit rate adaptive encoding method determination unit may be learned by a neural network designed to learn through supervised learning.

Meanwhile, as an example of setting a correct encoding method, when a plurality of encoding methods are applied to a compression ratio determination parameter of a sample, an encoding method that maximizes a compression ratio gain (e.g., a BD-rate gain) may be set as a correct answer.

An optimal encoding method for an encoding input signal is determined through a compressed bit rate adaptive encoding method determination unit described below. Once an optimal encoding method for an encoding input signal is determined, an encoding input signal may be transformed and compressed into an encoding target signal based on a corresponding encoding method.

Transforming an encoding target signal may include at least one of selecting only part of an encoding input signal or transforming an encoding input signal to low resolution. According to a determined optimal encoding method, a process of transforming an encoding target signal may be omitted.

In a decoding process, a compressed encoding target signal may be reconstructed based on an optimal encoding method. In addition, an encoding input signal may be reconstructed by inversely transforming a reconstructed encoding target signal.

Based on the above-described description, an image encoding method and a device therefor, and an image decoding method and a device therefor according to the present disclosure will be described in detail.

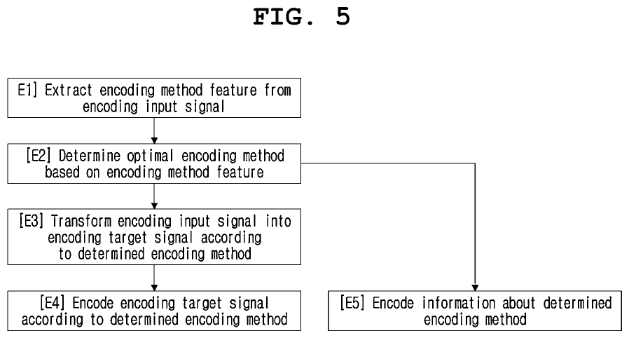

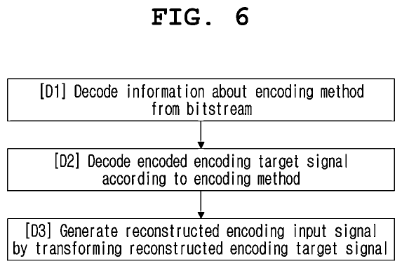

FIGS. 5 and 6 are a flowchart of an image encoding method and an image decoding method according to an embodiment of the present disclosure, respectively.

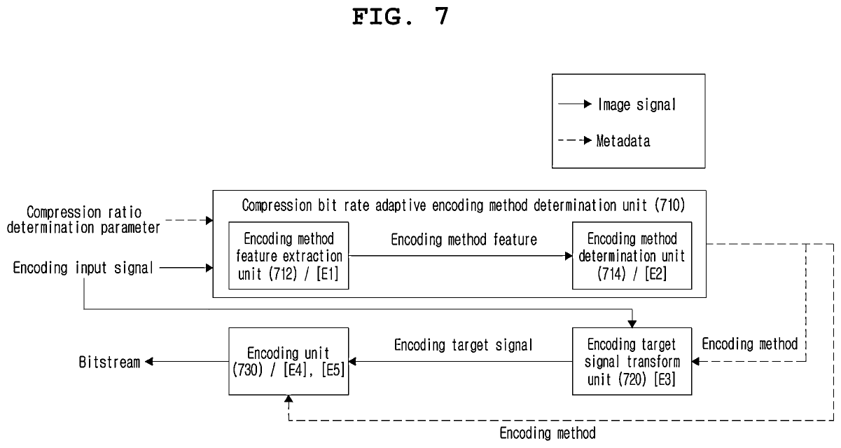

In addition, FIG. 7 shows a block diagram of an image encoder for performing an image encoding method shown in FIG. 5.

Referring to FIG. 7, an image encoder may include a compression bit rate adaptive encoding method determination unit 710, an encoding target signal transform unit 720 and an encoding unit 730.

Although not shown, an image encoder may further include a feature map extraction unit 210 shown in FIG. 2. A feature map extraction unit 210 may extract an encoding input signal from an original image.

A compression bit rate adaptive encoding method determination unit 710 may include an encoding method feature extraction unit 712 for performing a step of extracting an encoding method feature [E1] and an encoding method determination unit 714 for performing a step of determining an encoding method [E2].

An encoding target signal transform unit 720 may perform a step of transforming an encoding input signal into an encoding target signal [E3].

An encoding unit 730 may perform an encoding step of an encoding target signal [E4] and an encoding step of encoding method information [E5].

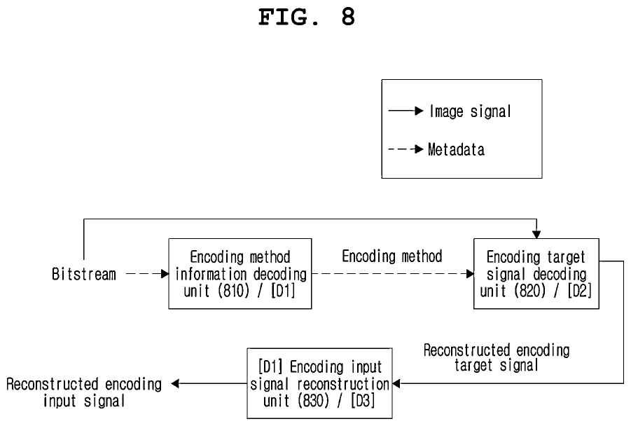

FIG. 8 shows a block diagram of an image decoder for performing an image decoding method shown in FIG. 6.

Referring to FIG. 8, an image decoder may include an encoding method information decoding unit 810, an encoding target signal decoding unit 820 and an encoding input signal reconstruction unit 830.

An encoding method information decoding unit 810 may perform a step of reconstructing encoding method information from a bitstream [D1].

An encoding target signal decoding unit 820 may perform a step of decoding encoded encoding information [D2] according to an encoding method.

An encoding input signal reconstruction unit 830 may perform a step of transforming a reconstructed encoding target signal [D3].

Although not shown, an image decoder may further include a machine task performance unit 220 shown in FIG. 2. A machine work performance unit 220 may perform a machine work based on a reconstructed encoding input signal.

Hereinafter, an image encoding method/device and an image decoding method/device according to the present disclosure will be described in detail.

### [E1] Step of Extracting an Encoding Method Feature

An encoding method feature extraction unit extracts a feature for determining an encoding method based on an encoding input signal and compression ratio determination parameter information. In this case, a feature for determining an encoding method may be referred to as an encoding method feature.

An optimal encoding method is determined by a compression ratio determination parameter of a sample. Accordingly, in order to determine an optimal encoding method, an encoding method feature may be extracted based on a compression ratio determination parameter of a sample.

An encoding input signal may be at least one of a still image, an entire or specific frame of a video, a single-layer feature map, some or all layers of a multi-layer feature map, a feature vector, a block generated by partitioning an image or a block generated by partitioning a feature map. Alternatively, when resolution is adjusted for listed data, it may be set as an encoding input signal.

When an encoding input signal is a feature map, a signal input to an encoding method feature extraction unit may be a feature map or may be an original image before a feature map is extracted.

As a compression ratio determination parameter is a parameter used to determine a compression bit rate, it may be a parameter used for a traditional (or, non-artificial neural network-based) image compression codec (e.g., HEVC, VVC or AV1) or an artificial neural network-based compression codec (e.g., End-to-End Neural Network).

As an example, under a traditional image compression codec, a quantization parameter (QP) that determines a quantization degree may be set as a compression ratio determination parameter.

Meanwhile, when an artificial neural network-based compression codec is used, a compression ratio may be adjusted through an optimized ratio between a compression bit rate and a distortion degree of an original image and a reconstructed image. Accordingly, under an artificial neural network-based compression codec, the ratio or a parameter for determining the ratio may be set as a compression ratio determination parameter.

An encoding method feature derived based on a compression ratio determination parameter may be a single-layer feature map or a multi-layer feature map having spatial resolution and a channel. Alternatively, a feature derived from a compression ratio determination parameter may be a feature vector that does not have spatial resolution and has only a channel.

An encoding method feature extraction unit may be implemented by using a convolutional neural network or an artificial neural network using a fully connected layer.

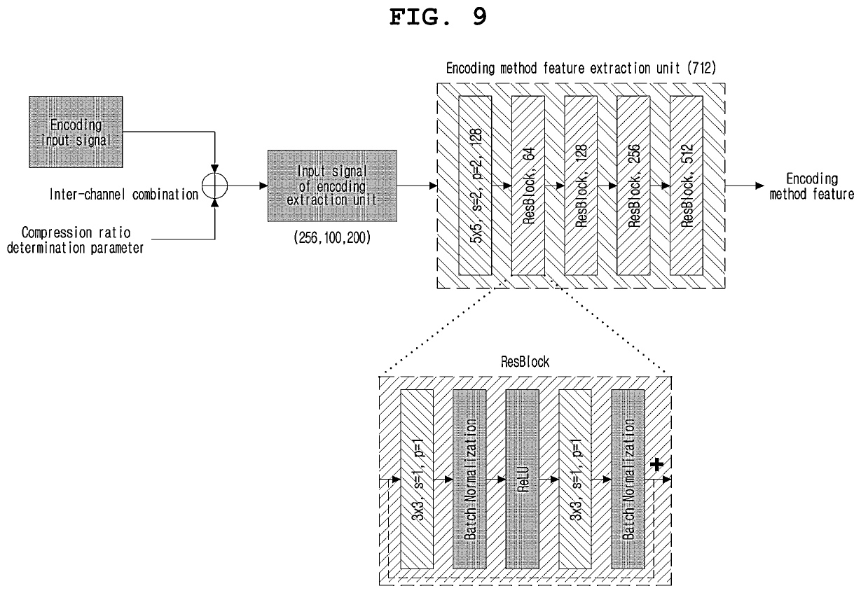

FIG. 9 illustrates an encoding method feature extraction unit built based on an artificial neural network.

In an example shown in FIG. 9, it was illustrated that an encoding method feature extraction unit includes a convolution layer and a residual block (ResBlock) layer.

In addition, it was illustrated that a size of a convolution filter of a convolution layer is 5×5, a size of a stride(s) is 2, a size of a padding (p) is 2 and the number of output channels is 128.

A convolution layer with a large filter size may be used to reduce the resolution of a signal input to an encoding method feature extraction unit and input an input signal whose resolution is transformed to a convolution layer with a small filter size.

A residual block layer may be implemented in a structure that performs an active function such as batch normalization and ReLU between convolutions and re-performs batch normalization after a last convolution.

In addition, an encoding method feature extraction unit may have a structure in which residual block layers are connected consecutively. In other words, a signal output through the last batch normalization of a previous residual block layer may be input to a current residual block layer. Meanwhile, a number indicated in a residual block layer (64, 128, 256, 512) represents the number of output channels of a residual block layer. As an example, “ResBlock, 64” represents that the number of output channels of a corresponding residual block layer is 64.

Referring to an example shown in FIG. 4, Encoding Method 3 is selected in a low compression ratio section, Encoding Method 2 is selected in a medium compression ratio section and Encoding Method 1 is selected in a high compression ratio section. In other words, in a high compression ratio section, it is highly unlikely that Encoding Method 3 is an optimal encoding method.

In other words, as a compression ratio increases, the order of encoding methods expected to be selected is highly likely to be the order of Encoding Method 3, Encoding Method 2 and Encoding Method 1 according to an example in FIG. 4.

Meanwhile, there may be a case in which prediction for an encoding method is wrong. In this case, rather than a case in which prediction is wrongly performed at a point where performance between encoding methods is crossed (e.g., a boundary between a low compression bit rate range and a medium compression bit rate range, or a boundary between a medium compression bit rate range and a high compression bit rate range), a case in which prediction is wrongly performed at a point far from a point where performance between encoding methods is crossed may cause a larger performance decline.

As an example, in an example of FIG. 4, even if Encoding Method 1, not Encoding Method 2, is selected in a section close to a high compression bit rate range among the medium compression bit rate ranges, it will not have a significant effect on the overall performance. On the other hand, if Encoding Method 1, not Encoding Method 2, is selected in a section close to a low compression bit rate range among the medium compression bit rate ranges, it may cause a significant fall in the overall performance.

Accordingly, a structure and a loss function for learning may be designed by considering the selection order of encoding methods according to a compression ratio. In other words, the selection order of encoding methods according to a compression ratio may be maintained to minimize an effect on the overall performance when prediction is wrong.

Meanwhile, in order to maintain the selection order of encoding methods, at least one of arranging encoding methods according to a compression ratio (i.e., arranging selection order among the encoding methods) and arranging a compression ratio for a specific encoding method (i.e., arranging order within an encoding method) may be performed.

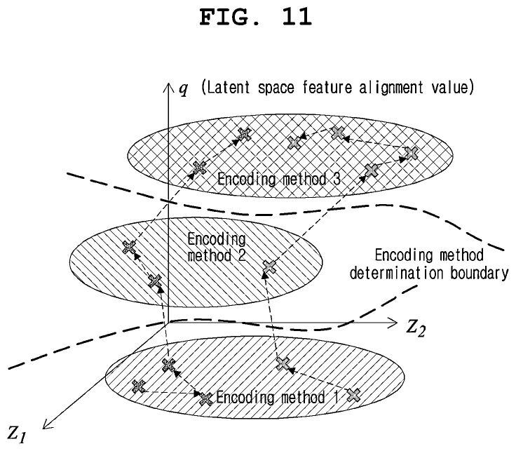

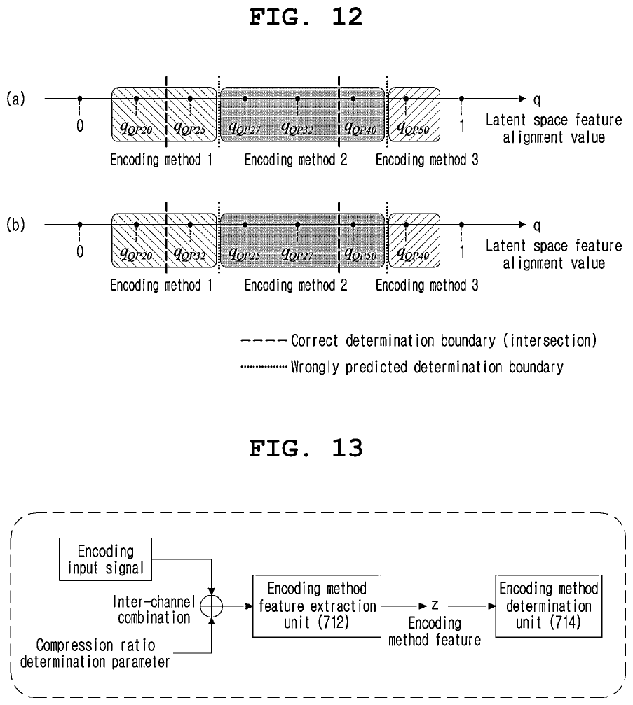

FIGS. 11 and 12 show an example in which order among the encoding methods is maintained.

A compression ratio is determined by a compression ratio determination parameter. Accordingly, in order to maintain the selection order of encoding methods according to an increase in a compression ratio, a relationship between a size of a compression ratio determination parameter and an index of encoding methods may be set to be an increasing function relationship.

As an example, in the latent space of an encoding method feature, an encoding method feature (z) may be arranged for one axis according to the order of encoding methods (i.e., an index of encoding methods). Here, an axis where an encoding method feature is arranged may be referred to as a ‘latent space alignment axis’. In addition, a value for a latent space alignment axis may be referred to as a ‘latent space feature alignment value’ (q). In this case, a loss function that sets a relationship between a latent space feature alignment value (q) and an index of encoding methods to be an increasing function relationship may be used.

For example, if an example of FIG. 4 is followed, a latent space feature alignment value (q) of an encoding method feature (z) using Encoding Method 3 may be smaller than a latent space feature alignment value (q) of an encoding method feature (z) using Encoding Method 2. Similarly, a latent space feature alignment value (q) of an encoding method feature (z) using Encoding Method 2 may be smaller than a latent space feature alignment value (q) of an encoding method feature (z) using Encoding Method 1.

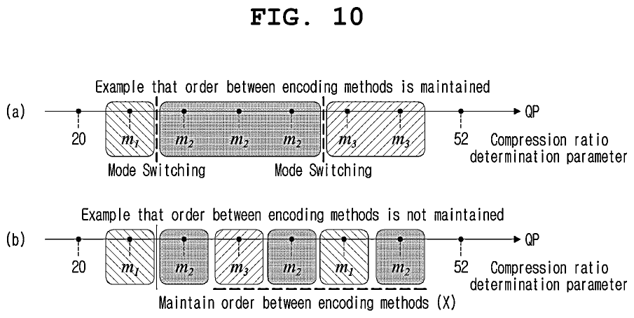

FIGS. 10(a) and 10(b) show an example of comparing a case in which the selection order of encoding methods is maintained according to a compression ratio determination parameter and a case in which it is not.

m represents an encoding method. In addition, FIGS. 10(a) and 10(b) illustrate a case in which three encoding methods exist.

In FIG. 10(a), it was shown that a size of a compression ratio determination parameter (i.e., a quantization parameter) and selected encoding methods are not crossed. As an example, it was illustrated that for a small-sized quantization parameter, only Encoding Method 1 (m1) is selected, for a medium-sized quantization parameter, only Encoding Method 2 (m2) is selected and for a large-sized quantization parameter, Encoding Method 3 (m3) is selected. In this case, a quantization parameter (i.e., a threshold) of a specific size may become a selection boundary for two encoding methods.

On the other hand, in FIG. 10(b), it was shown that a size of a compression ratio determination parameter (i.e., a quantization parameter) and selected encoding methods may be crossed. As an example, it was illustrated that for a medium-sized quantization parameter, Encoding Method 3 (m3) as well as Encoding Method 2 (m2) are selected and for a large-sized quantization parameter, Encoding Method 1 (m1) as well as Encoding Method 3 (m3) are selected.

FIG. 11 shows an example in which an encoding method feature is arranged according to an encoding method on a latent space feature alignment axis on a latent space.

A X mark on a drawing represents an encoding method feature according to a change in a compression ratio. An arrow indicates a direction of an increase in a compression ratio.

Next, arrangement of a compression ratio for a specific encoding method (i.e., order arrangement within an encoding method) will be described. For a plurality of compression ratio determination parameters using a specific encoding method, a compression ratio determination parameter and a latent space feature alignment value may be set to have an increasing function relationship. In other words, for a specific encoding method, a rank of a latent space feature alignment value may be the same as a rank of a corresponding compression ratio determination parameter.

FIGS. 12(a) and 12(b) show an example in which an error occurs in prediction of an encoding method.

FIG. 12(a) shows an example of a case in which the order of selected encoding methods is maintained as a compression ratio determination parameter increases, and FIG. 12(b) shows an example of a case in which selection order among the coding methods is not considered.

In an example shown in FIG. 12, it was illustrated that when selection order between encoding methods is maintained, a sample with a relatively lower compression ratio determination parameter is misclassified compared to a case in which it is not so. In other words, in FIG. 12(a), misclassification occurred when a quantization parameter was 25 (QP25), but in FIG. 12(b), misclassification occurred when a quantization parameter was 32 (QP32). In other words, when selection order between encoding methods is maintained, misclassification occurs at the selection boundary of encoding methods, and accordingly, the overall performance decline is small. On the other hand, when selection order between encoding methods is not considered, misclassification occurs at a point far from the selection boundary of encoding methods, and accordingly, the overall performance decline may be large.

Arrangement of a compression ratio for a specific encoding method (i.e., order arrangement within an encoding method) may minimize performance decline when a boundary between encoding methods is incorrectly predicted.

Considering the above embodiment, in the present disclosure, it is described by distinguishing between an embodiment in which a compression bit rate adaptive encoding method determination unit determines an encoding method by considering the selection order of encoding methods and an embodiment in which an encoding method is determined without considering the selection order of encoding methods.

[E1-1] an Embodiment in which an Encoding Method is Determined without Considering the Selection Order of Encoding Methods

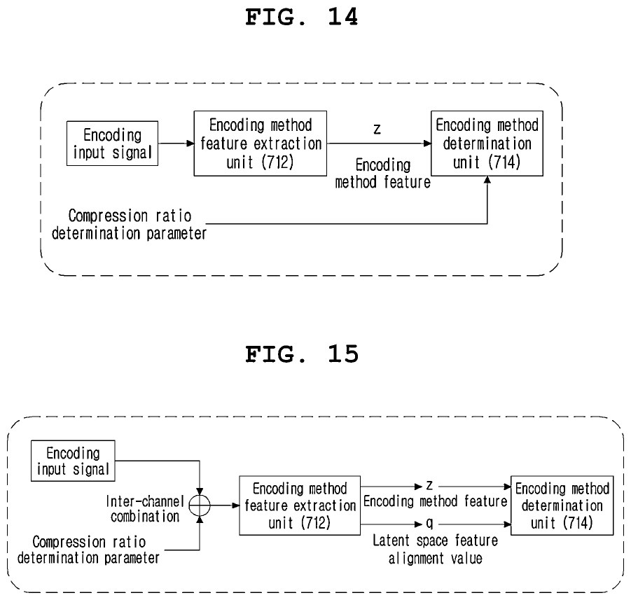

FIGS. 13 and 14 show an example in which an encoding method is determined without considering the selection order of encoding methods.

In the present disclosure, an encoding method feature is marked with variable z.

FIG. 13 shows an example in which both an encoding input signal and a compression ratio determination parameter are used as input to an encoding method feature extraction unit. An encoding method feature extraction unit may extract encoding method feature z based on an input encoding input signal and a compression ratio determination parameter. Extracted encoding method feature z may be used as input to an encoding method determination unit.

On the other hand, FIG. 14 shows an example in which only an encoding input method is used as input to an encoding method feature extraction unit. An encoding method feature unit may extract encoding method feature z from an input encoding input signal. A compression ratio determination parameter may be input to an encoding method determination unit along with extracted encoding method feature z.

[E1-1] an Embodiment in which an Encoding Method is Determined without Considering Encoding Method Order

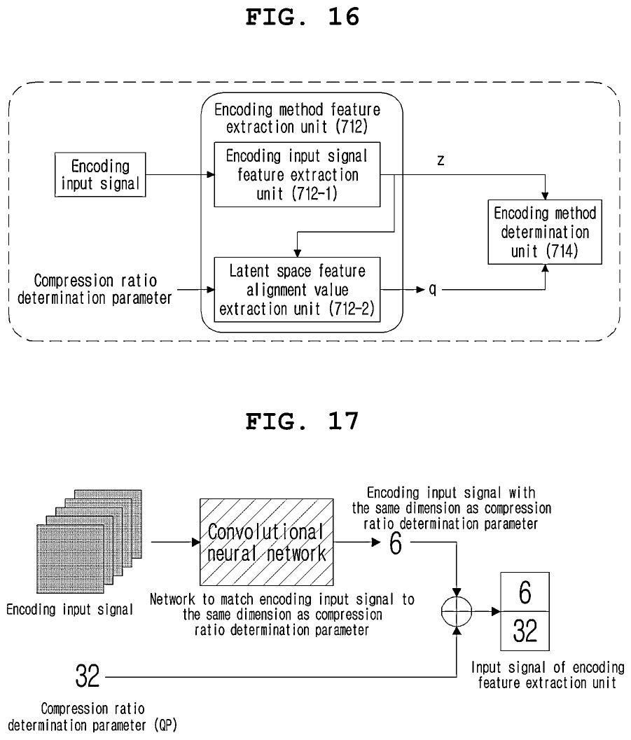

FIGS. 15 and 16 show an example in which an encoding method is determined by considering the selection order of encoding methods.

When the selection order of encoding methods is considered, latent space feature alignment value q may be used along with encoding method feature z.

FIG. 15 shows an example in which both an encoding input signal and a compression ratio determination parameter are used as input to an encoding method feature extraction unit. An encoding method feature extraction unit may extract encoding method feature z and latent space feature alignment value q based on an input encoding input signal and a compression ratio determination parameter. Extracted encoding method feature z and latent space feature alignment value q may be used as input to an encoding method determination unit.

As an example in which an encoding method feature extraction unit extracts encoding method feature z and latent space feature alignment value q, the same structure as in FIG. 16 may be used. In FIG. 16, it was illustrated that an encoding method feature extraction unit includes an encoding input signal feature extraction unit and a latent space feature alignment value extraction unit.

Specifically, when an encoding input signal is input to an encoding method feature extraction unit, an encoding method feature extraction unit outputs encoding method feature z.

Afterwards, a compression ratio determination parameter and encoding method feature z are input to a latent space feature alignment value extraction unit. A latent space feature alignment value extraction unit outputs latent space feature alignment value q based on input data.

Encoding method feature z output from an encoding method feature extraction unit and latent space feature alignment value q output from a latent space feature alignment value extraction unit may be input to an encoding method determination unit, respectively.

When an encoding input signal and a compression ratio determination parameter are input together to an encoding method feature extraction unit, a process of merging them in a channel direction may be performed according to a bilateral dimension.

FIG. 17 shows an example in which an encoding input signal and a compression ratio determination parameter are merged.

In order to make a dimension of an encoding input signal the same as a dimension of a compression ratio determination parameter, an encoding input signal may be passed through a convolutional neural network or a fully connected layer.

As an example, if the spatial resolution of an encoding input signal is 100×200 and an encoding input signal has 256 channels, a dimension of an encoding input signal may be expressed as (256, 100, 200). Meanwhile, when a compression ratio determination parameter is one scalar value, an encoding input signal may be transformed into one scalar value by passing it through a convolutional neural network or a fully connected network.

Afterwards, a value obtained by merging a dimensionally transformed encoding input signal and a compression ratio determination parameter in a channel direction or by adding a dimensionally transformed encoding input signal and a compression ratio determination parameter may be used as input to an encoding method feature extraction unit.

In FIG. 17, it was illustrated that a signal of two channels obtained by merging two scalar values (i.e., a dimensionally transformed encoding input signal and a compression ratio determination parameter) in a channel direction is set as input to an encoding feature unit.

Meanwhile, if an encoding input signal is a feature vector that does not have spatial resolution, a dimension change for an encoding input signal may not be performed. In other words, an input signal of an encoding method feature extraction unit may be generated by merging an encoding input signal and a compression ratio determination parameter in a channel direction.

As another example, a compression ratio determination parameter may be transformed according to the spatial resolution of an encoding input signal.

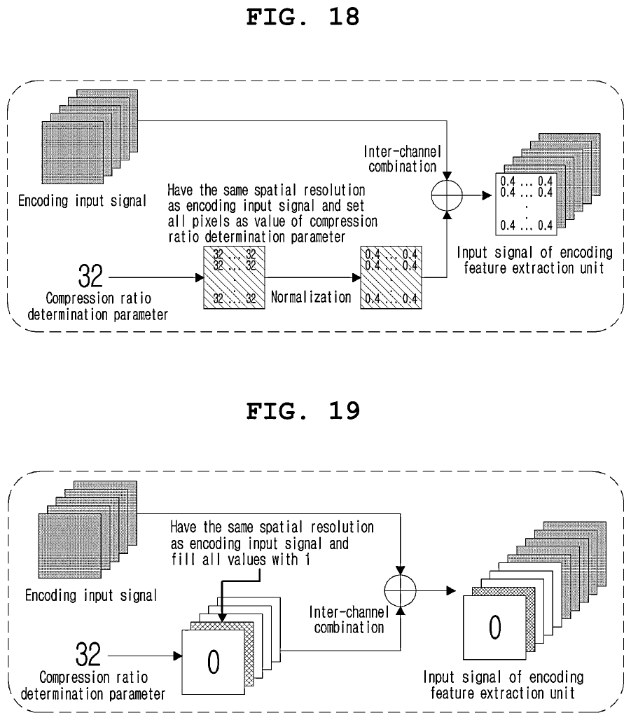

FIGS. 18 and 19 show an example in which a compression ratio determination parameter is transformed according to the spatial resolution of an encoding input signal.

A compression ratio determination parameter of a single channel may be transformed to the same spatial resolution as an encoding input signal.

As an example, as in an example shown in FIG. 18, a transformed compression ratio determination parameter may be a picture in which each pixel value is set as a value of a compression ratio determination parameter.

In this case, through a normalization process, a range of an encoding input signal and a compression ratio determination parameter may be matched.

As an example, when a dimension of an encoding input signal is (256, 100, 200), an input signal of a compression ratio determination parameter may be transformed to a dimension of (1, 100, 200) by matching it to a spatial signal of an encoding input signal. When two signals above are combined on a channel axis, a signal of (257, 100, 200) is generated. A signal generated above may be set as an input signal of an encoding method feature extraction unit.

Alternatively, as in an example shown in FIG. 19, a compression ratio determination parameter of a plurality of channels may be transformed to the spatial resolution of an encoding input signal. Here, each channel may correspond to a compression ratio determination parameter of a different value. In other words, the number of available compression ratio determination parameters may be determined and set as the number of channels.

Order between channels may be determined according to a compression ratio determination parameter.

A channel corresponding to a compression ratio determination parameter to be used among a plurality of channels may be activated, and other channels may be deactivated. As an example, as in an example shown in FIG. 19, each pixel value in a channel corresponding to a compression ratio determination parameter to be used among a plurality of channels may be set as 1 and each pixel value in other channels may be set as 0.

As an example, it is assumed that a dimension of an encoding input signal is (256, 100, 200) and the number of available compression ratio parameters is 10 (e.g., an integer value from 1 to 10). In this case, a transformed compression ratio determination parameter may have a dimension of (10, 100, 200).

Meanwhile, if a compression ratio determination parameter to be used is 3 (i.e., a third channel), all values of a third channel may be set as 1, while all values of the remaining channels may be set as 0.

When two signals above are combined on a channel axis, a signal with a dimension of (266, 100, 200) is generated. A signal generated above may be set as an input signal of an encoding method feature extraction unit.

Next, a method for learning an encoding method feature extraction unit will be described in detail.

Supervised learning may be applied to learning of an encoding method feature extraction unit. In other words, an encoding method optimal for a sample compression ratio determination parameter of an encoding input signal (i.e., a correct encoding method) may be determined in advance, and an encoding method feature extraction unit may be learned.

In this case, an optimal encoding method (i.e., a correct encoding method) may be an encoding method with the maximum compression ratio-to-performance gain (BD-rate gain) according to a sample of an encoding input signal and a compression ratio determination parameter of the sample among a plurality of encoding methods.

Alternatively, an encoding method that compression ratio-to-performance gain according to a size of an object in an encoding input signal is maximized may be selected as an optimal encoding method. In other words, an optimal encoding method may be selected according to an object size and a compression bit rate.

A loss function for maintaining selection order between encoding methods according to a compression ratio may be used. Specifically, a loss function may be applied to latent space feature alignment value q.

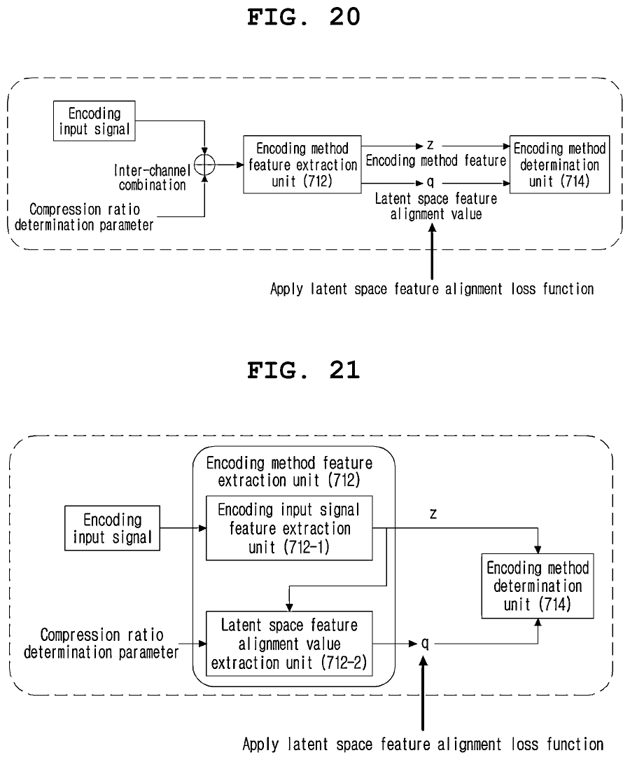

FIGS. 20 and 21 show an example in which a loss function is applied to a latent space feature alignment value.

As another example, in order to maintain the selection order of encoding methods, a feature value center alignment loss function may be used. A feature value center alignment loss function is a loss function for ensuring that a latent space feature alignment value is positioned close to a median value for an optimal encoding method (i.e., a correct encoding method).

In this case, a median value may be predetermined by a hyper-parameter. Alternatively, a median value may be determined by learning.

A feature value center alignment loss function may be a L1 loss function or a L2 loss function that minimizes a difference between a latent space feature alignment value and a median value.

FIG. 22 is an exemplary diagram for describing a feature value center alignment loss function.

For convenience of a description, it is assumed that there are three selectable encoding methods. In FIG. 22, each of C1, C2 and C3 represents a median value corresponding to an optimal encoding method.

y indicates an index of an optimal encoding method. As an example, q_{y=1} represents a latent space alignment value that an encoding method with an index of 1 is an optimal encoding method (i.e., a correct encoding method).

A feature value center alignment loss function may set latent space alignment value q_{y=1} to be close to ci, a median value of an optimal encoding method. Accordingly, a loss function may utilize a distance between latent space alignment value q_{y=1} and c₁, a median value of an optimal encoding method, as a variable.

Equation 1 shows an example of a feature value central loss function, which is a L2 loss function.

$$loss = {( {c}_{1} - {q}_{y = 1} )}^{2} \qquad [ Equation l ]$$

As another example, in order to maintain the selection order of encoding methods, a feature value alignment loss function using a threshold may be used. A feature value alignment loss function using a threshold may set a latent space feature alignment value to be within a threshold range of an optimal encoding method (i.e., a correct encoding method) or to be close to a threshold range.

As an example, if a latent space feature alignment value is within a threshold range of an optimal encoding method (i.e., a correct encoding method), a value of a loss function may be set as 0. On the other hand, if a latent space feature alignment value is outside a threshold range of an optimal encoding method (i.e., a correct encoding method), a L1 loss function or a L2 loss function that minimizes a difference from a threshold may be applied to a latent space feature alignment value.

Meanwhile, a threshold may be predetermined by a hyper-parameter. Alternatively, a threshold may be determined by learning.

FIG. 23 is an exemplary diagram for describing a feature value alignment loss function using a threshold.

For convenience of a description, it is assumed that there are three selectable encoding methods. In an example shown in FIG. 23, a threshold range for a first encoding method may be from 0 to th₁, a threshold range for a second encoding method may be from th₁ to th₂ and a threshold range for a third encoding method may be from the to 1.

A latent space feature alignment value of a sample may be set to be within a threshold range of an optimal encoding method (i.e., a correct encoding method). As an example, latent space feature alignment value q_{y=2} whose index of an optimal encoding method is 2 must exist between th₁ and th₂, a threshold range for a second encoding method. Accordingly, when latent space feature alignment value q_{y=2} is smaller than th₁, a loss function that uses a distance between q_{y=2} and th₁ as a variable may be used to move q_{y=2} to th₁. On the other hand, if latent space feature alignment value q_{y=2} is greater than th₂, a loss function that uses a distance between q_{y=2} and th₂ as a variable may be used to move q_{y=2} to th₂. Meanwhile, if latent space feature alignment value q_{y=2} exists between th₁ and th₂, a loss function may not be applied.

Equation 2 shows an example of a feature value alignment loss function using a threshold applied to latent space feature alignment value q_{y=2} according to the example.

$$loss = {( t {h}_{1} - {q}_{y = 2} )}^{2} , ( {q}_{y = 2} < t {h}_{1} ) loss = 0 , ( t {h}_{1} \leq q + y = 2 \leq t {h}_{2} ) loss = {( t {h}_{2} - {q}_{y = 2} )}^{2} , ( t {h}_{2} < {q}_{y = 2} ) \qquad [ Equation 2 ]$$

As another example, in order to maintain the selection order of encoding methods, a feature value alignment loss function using a margin threshold may be used. A feature value alignment loss function using a margin threshold operates in the same way as a feature value alignment loss function using a threshold, but there is a difference that a margin is set between the thresholds of encoding methods.

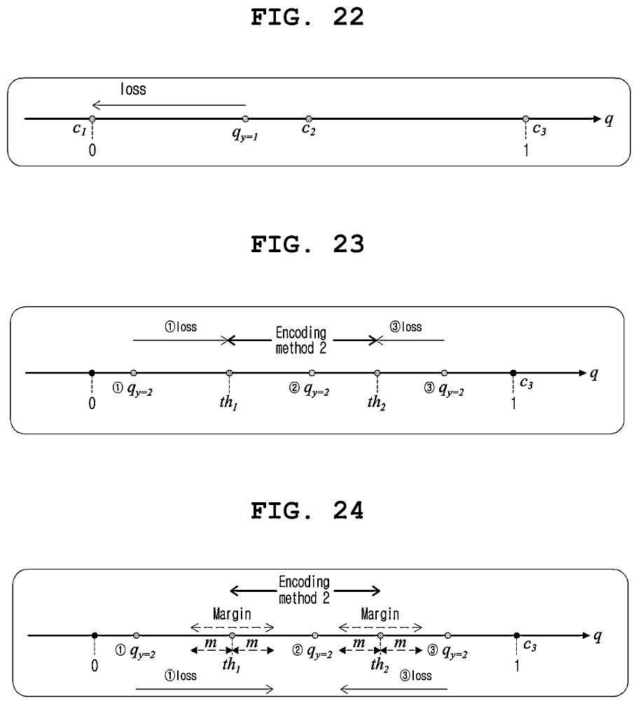

FIG. 24 is an exemplary diagram for describing a feature value alignment loss function using a margin threshold.

As in an example shown in FIG. 24, a margin by m may be set before and after a boundary th₁ between a first encoding method and a second encoding method. In addition, a margin by m may be set before and after a boundary th₂ between a second encoding method and a third encoding method.

Accordingly, a threshold range for a first encoding method may be from 0 to (th₁−m), a threshold range for a second encoding method may be from (th₁+m) to (th₂−m) and a threshold range for a third encoding method may be from (th₂+m) to 1.

Meanwhile, in FIG. 24, it was illustrated that a margin is set both before and after a boundary between two encoding methods, but it is also possible to set a margin only before a boundary between two encoding methods or to set a margin only after a boundary between two encoding methods.

A latent space feature alignment value may be set to be within a threshold range of an optimal encoding method excluding a margin. As an example, in an example shown in FIG. 24, a loss function for latent space feature alignment value q_{y=2} where an index of an optimal encoding method is 2 may be defined as Equation 3.

$$loss = {( ( t {h}_{1} + m ) - {q}_{y = 2} )}^{2} , ( {q}_{y = 2} < {th}_{1} ) loss = 0 , ( t {h}_{1} \leq {q}_{y = 2} \leq t {h}_{2} ) loss {( ( t {h}_{2} - m ) - {q}_{y = 2} )}^{2} , ( t {h}_{2} < {q}_{y = 2} ) \qquad [ Equation 3 ]$$

At least one of a plurality of loss functions described above may be used to learn an encoding method feature extraction unit.

Alternatively, at least two of a plurality of loss functions described above may be used to learn an encoding method feature extraction unit. As an example, based on a ‘feature value center alignment loss function’, an encoding method feature extraction unit may be learned initially, and a ‘feature value alignment loss function using a threshold’ may be used to fine-tune an encoding method feature extraction unit.

Meanwhile, in applying a loss function, a threshold range may be subdivided by encoding method.

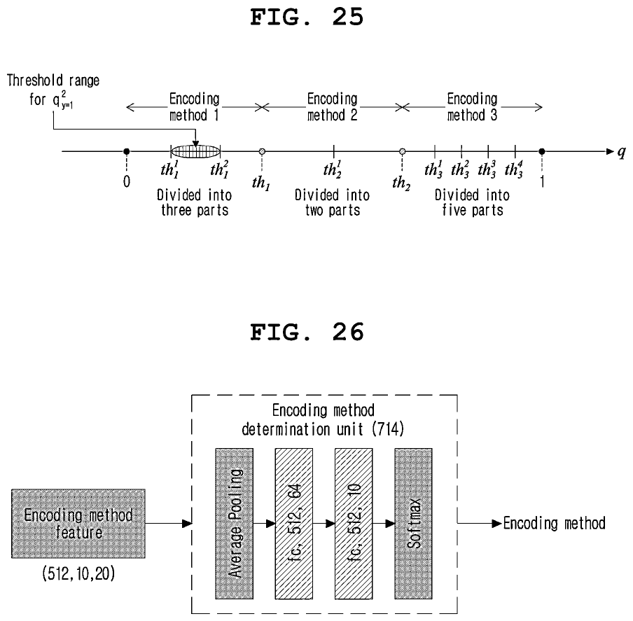

FIG. 25 shows an example in which a threshold range is subdivided by encoding method.

The threshold range for an encoding method can be divided by the number of compression rate determination parameter candidates that use the corresponding encoding method as the optimal encoding method.

For convenience of a description, it is assumed that the number of available compression ratio determination parameter candidates is 10 and the number of selectable encoding methods is 3. As an example, 10 compression ratio determination parameter candidates may be {1, 2, 3, 4, 5, 6, 7, 8, 9, 10}.

When the number of compression ratio determination parameter candidates using Encoding Method 1 as an optimal encoding method is 3 (e.g., {1, 2, 3}), as in an example shown in FIG. 24, a threshold range of Encoding Method 1 may be divided into three parts. Similarly, when the number of compression ratio determination parameter candidates using Encoding Method 2 as an optimal encoding method is 2 (e.g., {4, 5}), as in an example shown in FIG. 24, a threshold range of Encoding Method 2 may be divided into two parts. In addition, if the number of compression ratio determination parameter candidates using Encoding Method 3 as an optimal encoding method is 5, a threshold range of Encoding Method 3 may be divided into five parts.

In other words, a threshold range may be set as many as the number of compression ratio determination parameter candidates. Each threshold range may correspond to a different compression ratio determination parameter candidate. Accordingly, a loss function may be used to ensure that a latent space feature alignment value derived from a predetermined compression ratio determination parameter candidate is included in a corresponding threshold range. As an example, if a latent space feature alignment value derived from a predetermined compression ratio determination parameter candidate is not included in a corresponding threshold range, a loss function that moves a latent space feature alignment value to a corresponding threshold range may be applied. On the other hand, when a latent space feature alignment value derived from a predetermined compression ratio determination parameter candidate is included in a corresponding threshold range, a loss function may not be applied to a latent space feature alignment value.

In an example shown in FIG. 25, q^{N}_{y=M} represents a latent space feature alignment value where a value of a compression ratio determination parameter is N and an encoding method with an index of M is an optimal encoding method. Latent space feature alignment value q²_{y=1} must exist in a second partitioned threshold range (i.e., (th¹₁ to th²₁)) among the partitioned threshold ranges for Encoding Method 1. If latent space feature alignment value q²_{y=1} is out of a second partitioned threshold range, latent space feature alignment value q²_{y=1} may be adjusted to be within a second partitioned threshold range by using a loss function that uses a distance between a boundary of a second partitioned threshold range and latent space feature alignment value q²_{y=1} as a variable. On the other hand, if latent space feature alignment value q²_{y=1} exists in a second partitioned threshold range, a loss function may not be applied.

Equation 4 represents an example of a L2 loss function applied to latent space feature alignment value q²_{y=1} according to the example.

$$loss = {( t {h}_{1}^{1} - {q}_{y = 2}^{2} )}^{2} , ( {q}_{y = 2}^{2} < t {h}_{1}^{1} ) loss = 0 , ( t {h}_{1}^{1} \leq {q}_{y = 2}^{2} \leq t {h}_{1}^{2} ) {loss ( {th}_{1}^{2} - {q}_{y = 2}^{2} )}^{2} , ( {th}_{1}^{2} < {q}_{y = 2}^{2} ) \qquad [ Equation 4 ]$$

### [E2] Step of Determining an Encoding

An encoding method determination unit receives an encoding method feature output from an encoding method feature extraction unit as input and determines/outputs an optimal encoding method. As an example, an encoding method determination unit may output an index of one of a plurality of predefined encoding methods in response to an encoding method feature.

Meanwhile, encoding method information may be additionally input to an encoding method determination unit. Encoding method information may include information showing whether to adjust resolution. As an example, the information shows whether resolution adjustment was performed on an encoding input signal or a compression ratio determination parameter.

When resolution adjustment is performed on an encoding input signal or a compression ratio determination parameter, encoding method information may further include at least one of a resolution adjustment degree, a value of a changed compression ratio determination parameter or a difference value between a changed compression ratio determination parameter and an original compression ratio determination parameter.

Meanwhile, if a compression ratio determination parameter is not used as input to an encoding method feature extraction unit, a compression ratio determination parameter may be input to an encoding method determination unit.

An encoding method determination unit for determining an encoding method may be implemented by using a convolutional neural network or a fully connected layer. In addition, an encoding method determination unit may be implemented based on a classification algorithm such as a support vector machine (SVM) with relatively low complexity. Alternatively, an encoding method determination unit may be implemented by using a deterministic classification algorithm that is not capable of learning.

FIG. 26 shows an example in which an encoding method determination unit is implemented by using a fully connected layer.

As in an example shown in FIG. 26, Average Pooling may be used to transform an encoding method feature into a feature vector. Afterwards, a transformed feature vector may be passed through two fully connected layers, and then a softmax function may be applied to a result value thereof.

In FIG. 26, fc represents a fully connected layer. As an example, ‘fc, 512, 64’ refers to a fully connected layer that the number of input nodes is 512 and the number of output nodes is 64.

The number of output nodes of a last fully connected layer may be equal to the number of selectable encoding methods. An example shown in FIG. 26 illustrates a case in which the number of selectable encoding methods is 10.

To learn an encoding method determination unit, a classification loss function may be used. A classification loss function may minimize a difference between an index of an optimal encoding method (i.e., a correct encoding method) and an index of an encoding method predicted by an encoding method determination unit.

As an example, at least one of a cross-entropy loss function or a mean-squared error loss function may be used as a classification loss function.

As another example, if an encoding method predicted by an encoding method determination unit is different from an optimal encoding method (i.e., a correct encoding method), an effect on the overall performance may vary depending on an incorrectly predicted encoding method. Considering this, an encoding method determination unit may be learned by defining an effect of an encoding method on the overall performance decline as a risk and using a risk-taking classification loss function that minimizes a risk.

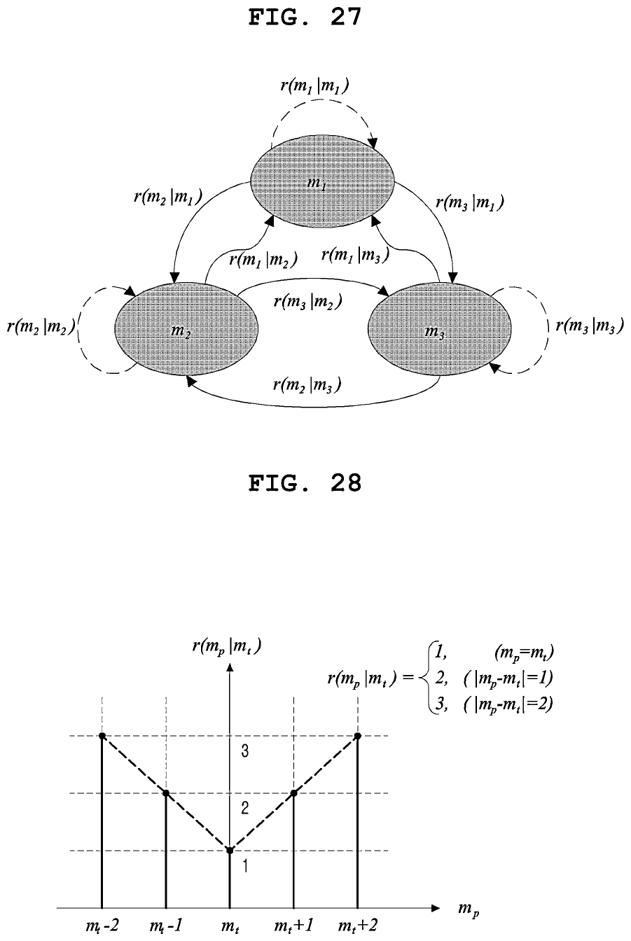

FIG. 27 is an exemplary diagram for describing a risk-taking classification loss function.

A risk function for reflecting a risk on a loss function may be defined. A risk function may be a function that uses an index of a correct encoding method and an index of a predicted encoding method as variables.

As an example, when an index of a correct encoding method (mode index of true label) is mₜ and an index of a predicted encoding method (mode index of predicted label) is mₚ, a risk function may be indicated as r(mₚ|mₜ).

In FIG. 27, each of m₁, m₂ and m₃ represents a selectable encoding method. As an example, r(m₁|m₂) represents a risk when a correct encoding method is m₂, but a predicted encoding method is m₁.

A risk function r(mₚ|mₜ) may be designed to ensure that a value increases as a difference between an index mₚ of a predicted encoding method and an index mₜ of a correct encoding method increases.

A risk function may be defined based on a function that was already known, such as an absolute value function or a quadric function.

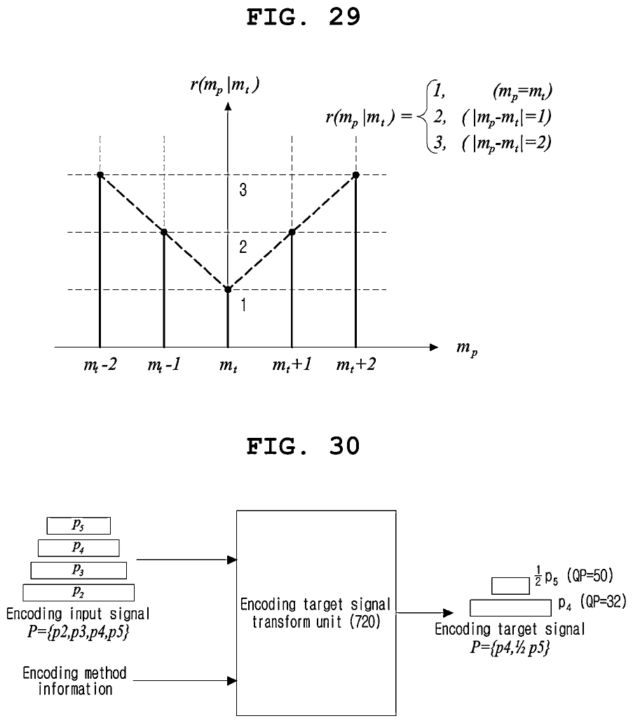

FIGS. 28 and 29 show an example of a risk function.

FIG. 28 shows an example in which a risk function is defined as an absolute value function, and FIG. 29 shows an example in which a risk function is defined as a quadric function.

As in an example shown in FIG. 28, when a risk function is an absolute value function, a risk may be proportional to an absolute value of a difference between mₚ and an index mₜ of a correct encoding method.

Alternatively, as in an example shown in FIG. 29, when a risk function is a quadric function, a risk may be proportional to a square of a difference between mₚ and an index mₜ of a correct encoding method.

In an example shown in FIGS. 28 and 29, it was illustrated that a risk is calculated without considering a value of an index mₜ of a correct encoding method, but it is also possible to calculate a risk by using a different function according to a value of an index mₜ of a correct encoding method.

As an example, if an index of a correct encoding method among a plurality of encoding methods is 1, a risk may be calculated based on a function shown in FIG. 28, and if an index of a correct encoding method among a plurality of encoding methods is 2, a risk may be calculated based on a function shown in FIG. 29.

Alternatively, a risk function may be implemented by statistically obtaining a risk from actual learning data. As an example, for all learning data, a loss size of a BD-rate may be obtained when an index mₜ of a correct encoding method is different from an index mₚ of a predicted encoding method. Afterwards, an average value of a BD-rate loss size for a (mₜ, mₚ) combination for all learning data may be set as a risk for a (mₜ, mₚ) combination.

As another example, an encoding method determination unit may be learned by using a cross-entropy loss function.

Equation 5 and Equation 6 show an example of a cross-entropy loss function. Specifically, Equation 5 represents cross-entropy loss function L that does not consider a risk function, and Equation 6 represents cross-entropy loss function L_{R} that considers a risk function.

$$L = {𝔼}_{i} \{ - {\sum }_{{m}_{p} = 1}^{M} [ {y}_{{m}_{t}}^{( i )} = 1 ] log {h}_{{m}_{p}} ( {x}^{( i )} ) \} \qquad [ Equation 5 ]$$

$${L}_{R} = {𝔼}_{i} \{ - {\sum }_{{m}_{t} = 1}^{M} {\sum }_{{m}_{p} = 1}^{M} r ( {m}_{p} \vert {m}_{t} ) [ {y}_{{m}_{t}}^{( i )} = 1 ] log {h}_{{m}_{p}} ( {x}^{( i )} ) \} \qquad [ Equation 6 ]$$

If Equation 5 is compared with Equation 6, in Equation 6, a risk value r(mₚ|mₜ) was utilized as a weight for a loss value. Accordingly, when a loss function in Equation 6 is used, a loss value may increase as a risk increases. Accordingly, an encoding method determination unit may be learned to ensure that a loss function value increases as a risk increases.

### [E3] Step of Transforming an Encoding Target Signal

An encoding target signal transform unit may transform an encoding input signal into an encoding target signal. Specifically, an encoding target signal transform unit may transform an encoding input signal into an encoding target signal for encoding according to an encoding method determined by an encoding method determination unit.

As an example, an encoding target signal transform unit may adjust the resolution of an encoding input signal to generate an encoding target signal. For example, when an encoding input signal is an image, an encoding target signal may be an image where resolution is reduced.

When an encoding input signal is a video, an encoding target signal may be all or partial frame of a video.

Alternatively, when an encoding input signal is a multi-layer feature map, an encoding target signal transform unit may set the entire or specific layer of a multi-layer feature map as an encoding target signal. Alternatively, an encoding target signal transform unit may generate an encoding target signal by adjusting resolution for the entire or specific layer of a multi-layer feature map.

As an example, if encoding input signal P is a multi-layer feature map composed of {p2, p3, p4, p5}, encoding target signal P_{enc} may be set as {p4, p5}, a partial layer of encoding target signal P, or may be set as {p4, ½ p5} by adjusting resolution for at least one layer of encoding target signal P. Here, {½ p5} means that a width and a height of a p5 layer are reduced by ½, respectively.

An encoding target signal may have a compression ratio determination parameter that is different from a compression ratio determination parameter of an encoding input signal.

FIG. 30 shows an example in which an encoding target signal has a compression ratio determination parameter different from an encoding input signal.

As an example, it is assumed that encoding input signal P is a multi-layer feature map composed of {p2, p3, p4, p5} and a compression ratio determination parameter for an encoding input signal (e.g., a quantization parameter) is 40.

In this case, encoding target signal P_{enc} may be set as {p4 (QP=50), ½ p5 (QP=32)}. Here, {p4 (QP=50)} represents that a quantization parameter for a p4 layer is set as 50, and {½ p5 (QP=32)} represents that a quantization for a p5 layer where resolution is reduced by ½ is set as 32.

Meanwhile, it is also possible to set an encoding input signal as an encoding target signal as it is, without transforming an encoding input signal. In other words, an image encoding method according to the present disclosure may be performed while omitting Step [E3].

### [E4] Step of Encoding an Encoding Target Signal

An encoding target signal may be encoded based on an encoding method determined by an encoding method determination unit. An encoding method for encoding an encoding target signal may be based on at least one of an image compression codec (e.g., HEVC, VVC or AV1) or an artificial neural network-based compression codec (e.g., End-to-End Neural Network).

### [E5] Step of Encoding Encoding Method Information/[D1] Step of Decoding Encoding Method Information

When an optimal encoding method is determined in an encoding method determination unit, information about a determined encoding method may be encoded.

As an example, encoding method information encoded by an encoding unit may include at least one of resolution adjustment information, a compression ratio determination parameter, a difference value of a compression ratio determination parameter, an encoding method indicator, the number of encoding target channels or identification information of an encoding target channel.

Resolution adjustment information may include at least one of information indicating whether resolution adjustment for a reconstructed encoding target signal should be performed or information about a resolution adjustment degree in a decoder.

Information indicating whether resolution adjustment should be performed may be a 1-bit flag. If resolution adjustment for a reconstructed encoding target signal is required (e.g., when a value of the flag is encoded as true), information showing a resolution adjustment degree may be additionally encoded/decoded.

A resolution adjustment degree may be set as a scale factor value.

If an encoding target signal is a multi-layer feature map, resolution adjustment information may be encoded/decoded for each layer. As an example, at least one of whether resolution adjustment is required or a resolution adjustment degree may be encoded/decoded for each layer.

When an encoding input signal is transformed according to an encoding method, if a compression ratio determination parameter is changed, a difference value between a value of a changed compression ratio determination parameter or a value of a compression ratio determination parameter before change (i.e., a value of a compression ratio determination parameter of an encoding input signal) and a value of a compression ratio determination parameter after change (i.e., a value of a compression ratio determination parameter of an encoding target signal) may be encoded/decoded.

Table 1 is to describe a configuration of encoding method information according to various examples of transforming an encoding input signal.

TABLE 1

| | | Compression Ratio | |
|---|---|---|---|
| | Resolution | Determination | Encoding |
| | Adjustment | Parameter | Method |
| | Degree | Difference Value | Indicator |
| Case 1 | x | 8 | x |
| Case 2 | p4, 1, {2, 4} | −8, | x |
| | p5, ½, {1} | 10 | |
| Case 3 | x | 8 | 2 |

Case 1 represents an example in which resolution adjustment is not applied to an encoding input signal, but a compression ratio determination parameter is changed from 32 to 40. In this case, a value of information indicating whether resolution adjustment should be performed may be set as False and encoded/decoded, or encoding/decoding of the information may be omitted. Meanwhile, a difference value between a value of a changed compression ratio determination parameter or a value of a compression ratio determination parameter before change and a value of a compression ratio determination parameter after change may be encoded and signaled. As an example, at least one of 8, a difference value between 32, a compression ratio parameter after change, and 40, a compression ratio parameter before change, and a sign therefor (i.e., a negative sign) may be encoded and signaled.

Case 2 represents an example in which an encoding input signal is a multi-layer feature map and only part of a multi-layer feature map is encoded/decoded. As an example, it is assumed that encoding input signal P is composed of {p2, p3, p4, p5} and a compression ratio determination parameter of each layer is 40. If an encoding target signal generated from the encoding input signal is {p4, p5}, encoding/decoding of a p2 layer and a p3 layer may be omitted. In this case, at least one of information showing the number of encoding target channels or identification information of an encoding target channel may be encoded and signaled.

Information showing the number of encoding target channels may represent the number of encoding target channels or the number of channels that are not an encoding target.

Identification information of an encoding target channel may be an identifier of an encoding target channel or a flag encoded for each channel. As an example, when a value of a flag is 1, it may represent that a corresponding channel is encoded/decoded, and when a value of a flag is 0, it may represent that a corresponding channel is not encoded/decoded.

When encoding/decoding of a p2 layer and a p3 layer is omitted, a decoder may decode a p4 layer and reconstruct a p3 layer and a p2 layer from a p4 layer. As an example, the resolution of p4 may be doubled to generate p3, and the resolution of p4 may be increased by four times to generate p2. Meanwhile, it was illustrated that a compression ratio determination parameter of a p4 layer is changed to 32. Accordingly, for a p4 layer, a difference value between a value of a changed compression ratio determination parameter or a value of a compression ratio determination parameter before change and a value of a compression ratio determination parameter after change may be encoded and signaled.

Meanwhile, it was illustrated that a p5 layer is encoded/decoded as resolution is reduced to ½. In this case, for a p5 layer, resolution adjustment information may be encoded/decoded. As an example, for a p5 layer, information indicating whether resolution adjustment should be performed may be set as True and encoded/decoded. In addition, information showing a resolution adjustment degree for a p5 layer may be additionally encoded/decoded. In addition, if a compression ratio determination parameter of a p5 layer is changed from 40 to 50, for a p5 layer, a difference value between a value of a changed compression ratio determination parameter or a value of a compression ratio determination parameter before change and a value of a compression ratio determination parameter after change may be encoded and signaled. As an example, at least one of 10, a difference value between 50, a compression ratio parameter after change, and 40, a compression ratio parameter before change, and a sign therefor (i.e., a positive sign) may be encoded and signaled.

Meanwhile, in a decoder, after reconstructing a p5 layer, the resolution of a p5 layer may be expanded according to a resolution adjustment degree.

Case 3 represents an example of a case in which at least one of a resolution adjustment degree or a difference value of a compression ratio determination parameter is predefined per encoding method. In other words, it represents an example of a case in which a resolution adjustment degree or a compression ratio determination parameter is predefined in an encoder and a decoder per index of an encoding method. In this case, encoding/decoding for at least one of a resolution adjustment degree or a value of a compression ratio determination parameter may be omitted, and only an index of an encoding method may be encoded and signaled.

A decoder may generate a reconstructed encoding input signal by transforming a reconstructed encoding target signal based on a resolution adjustment degree and/or a compression ratio determination parameter corresponding to an index of an encoding method.

For Case 3 in this example, 2 is encoded as an encoding method indicator value and transmitted to a decoder, and a decoder uses information such as a resolution adjustment degree or a compression ratio determination parameter difference value, etc. corresponding to encoding method indicator value 2 among information such as a resolution adjustment degree or a compression ratio determination parameter difference value, etc. stored in advance in a decoding process.

### [D2] Step of Decoding an Encoded Encoding Target Signal

An encoding target signal decoding unit may decode an encoded image signal (i.e., an encoded encoding target signal) according to an encoding method. In other words, an encoded image signal may be decoded based on a decoding method corresponding to an encoding method.

Meanwhile, a decoded image signal may be referred to as a reconstructed encoding target signal.

A decoding method may be based on at least one of an image compression codec (e.g., HEVC, VVC or AV1) or an artificial neural network-based compression codec (e.g., End-to-End Neural Network).

### [D3] Step of Reconstructing an Encoding Input Signal

An encoding target signal reconstruction unit performs inverse transform for transforming an encoding input signal into an encoding target signal in an encoding process. In other words, in an encoding process, when the resolution of an encoding target signal is different from the resolution of an encoding input signal, an encoding target signal reconstruction unit may transform a reconstructed encoding target signal according to the resolution of an encoding input signal. A signal generated by transforming a reconstructed encoding target signal may be referred to as a reconstructed encoding input signal or a reconstructed signal.

In order to adjust the resolution of a reconstructed encoding target signal, at least one of Super-Resolution (SR) using an artificial neural network or a resolution adjustment algorithm that has low complexity and does not require learning may be used.

As an example, Super-Resolution (SR) using an artificial neural network may be implemented based on at least one of CARN, VDSR or SRGAN.

As an example, a resolution adjustment algorithm may include bicubic or bilinear.

A method for adjusting the resolution of an encoding input signal in an encoding process may be the same as or different from a method for adjusting the resolution of a reconstructed encoding target signal in a decoding process.

As an example, the resolution of an encoding input signal may be adjusted based on SR using an artificial neural network in an encoding process, while the resolution of a reconstructed encoding target signal may be adjusted based on Bicubic in a decoding process.

Alternatively, even if resolution adjustment for an encoding input signal is not performed in an encoding process, resolution for a reconstructed encoding target signal may be adjusted (e.g., resolution may be increased) in a decoding process. Conversely, even if resolution adjustment for an encoding input signal is performed in an encoding process, resolution for a reconstructed encoding target signal may not be adjusted in a decoding process.

Meanwhile, when an encoding target signal is a multi-layer feature map, at least one of whether to adjust intra-layer resolution or a resolution adjustment degree may be set differently for each layer.

Here, intra-layer resolution adjustment refers to adjusting the resolution of a specific layer of a multi-layer feature map. If resolution for a specific layer of a multi-layer feature map that is an encoding input signal is adjusted in an encoding process, a specific layer of a reconstructed encoding target signal may be reconstructed according to the resolution of an encoding input signal in a decoding process. As an example, when the resolution of a P4ₒᵣᵢ layer of an encoding input signal is reduced by ¼ to generate encoding target signal P4_{enc}, reconstructed encoding input signal P4_{rec} may be generated by increasing the resolution of reconstructed encoding target signal P4_{dec} by four times.

Meanwhile, a reconstructed encoding input signal may be derived from a reconstructed encoding target signal through inter-layer resolution adjustment. Here, inter-layer resolution adjustment represents that a multi-layer feature map adjusts the resolution of a specific layer to derive another layer.

As an example, it is assumed that a multi-layer feature map includes P2, P3 and P4 layers and a width and a horizontal size and a vertical size are reduced by half from P2 to P4.

Among the multi-layer feature maps that are an encoding input signal, only a P4 layer may be set as an encoding target signal. In this case, only a P4 layer among the multi-layer feature maps may be encoded and decoded. Afterwards, P2 and P3 layers may be reconstructed from a decoded P4 layer (i.e., a reconstructed encoding target signal).

As an example, a P3 layer may be reconstructed by increasing the resolution of a P4 layer by two times, and a P2 layer may be reconstructed by increasing the resolution of a reconstructed P3 layer by two times. Through the process, a reconstructed encoding input signal including P2, P3 and P4 layers may be derived.

Alternatively, if a horizontal size and a vertical size are doubled from P2 to P4, the resolution of a P4 layer may be reduced by ½ to reconstruct a P3 layer. In addition, the resolution of a reconstructed P3 layer may be reduced by ½ to reconstruct a P2 layer.

If an encoding target signal is a block, resolution adjustment may be applied in a unit of a block. Here, a block may be generated by partitioning a still image, a video or a feature map.

A name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

What is claimed is:

1. A method of encoding an image, the method comprising:
extracting an encoding method feature from an encoding input signal;
based on the encoding method feature, determining an encoding method optimal for the encoding input signal;
based on the encoding method, transforming the encoding input signal; and
encoding an encoding target signal generated by transforming encoding method information and the encoding input signal.

2. The method of claim 1, wherein:
the encoding method information includes an encoding method index indicating the encoding method among a plurality of encoding method candidates.

3. The method of claim 1, wherein:
the encoding method feature is output as a response to inputting an input signal generated by combining the encoding input signal and a compression ratio determination parameter into a first machine learning model.

4. The method of claim 3, wherein the input signal is generated by:
transforming the compression ratio determination parameter according to a spatial resolution of the encoding input signal, and
combining a transformed compression ratio determination parameter and the encoding input signal in a channel direction.

5. The method of claim 3, wherein the input signal is generated by:
transforming the encoding input signal according to a dimension of the compression ratio determination parameter, and
combining a transformed encoding input signal and the compression ratio determination parameter in a channel direction.

6. The method of claim 3, wherein:
the compression ratio determination parameter is a multi-channel signal having a number of channels equal to a number of compression ratio determination parameter candidates, and
in the multi-channel signal, only a channel corresponding to a compression ratio determination parameter candidate to be used among the compression ratio determination parameter candidates is set to be activated.

7. The method of claim 3, wherein:
the first machine learning model is learned by applying a loss function to a latent space feature alignment value derived from the encoding method feature.

8. The method of claim 7, wherein:
the latent space feature alignment value is obtained by arranging the encoding method feature on a latent space alignment axis according to the compression determination parameter.

9. The method of claim 7, wherein:
the loss function uses a distance between the latent space feature alignment value and a median value of a correct encoding method as a variable.

10. The method of claim 7, wherein:
the loss function uses a distance between the latent space feature alignment value and a threshold range of a correct encoding method as a variable, and
the loss function is applied only when the latent space feature alignment value does not belong to the threshold range of the correct encoding method.

11. The method of claim 10, wherein:
the threshold range does not include a margin set around a boundary between encoding methods.

12. The method of claim 3, wherein:
the predicted encoding method is output as a response to inputting an output signal of the first machine learning model into a second machine learning model.

13. The method of claim 12, wherein:
the second machine learning model is learned based on a loss function based on a risk between the predicted encoding method and a correct encoding method.

14. The method of claim 13, wherein:
the risk increase as a difference between an index of the predicted encoding method and an index of the correct encoding method increases.

15. The method of claim 13, wherein:
the loss function is a function that uses the risk as a weight for a loss value.

16. The method of claim 1, wherein:
the encoding target signal is generated by adjusting at least one of a resolution or a number of channels of the encoding input signal.

17. The method of claim 16, wherein:
the encoding method information further includes resolution adjustment information for the encoding target signal.

18. The method of claim 1, wherein:
the encoding method information further includes difference value information between a compression ratio determination parameter of the encoding input signal and a compression ratio determination parameter of the encoding target signal.

19. An image decoding method, the method comprising:
receiving a bitstream including metadata and encoded image data;
decoding the encoded image data to generate a reconstructed encoding target signal; and
transforming the reconstructed encoding target signal to generate the reconstructed encoding target signal,
wherein:
the metadata includes encoding method information indicating an encoding method of the encoded image data, and
a decoding of the encoded image data is performed based on a decoding method corresponding to an encoding method indicated by the encoding method information.

20. A computer readable recording medium recording an image encoding method, the computer readable recording medium comprising:
extracting an encoding method feature from an encoding input signal;
based on the encoding method feature, determining an encoding method optimal for the encoding input signal;
based on the encoding method, transforming the encoding input signal;
encoding an encoding target signal generated by transforming encoding method information and the encoding input signal.
